(19) United States
(12) Patent Application Publication
(10) Pub. No.: US 2006/0120516 A1
(43) Pub. Date: Jun. 8, 2006

(54) Method and apparatus for providing push-to-talk based execution of an emergency plan

(76) Inventors: Peter J. Armbruster, Chandler, AZ (US); Michael D. Sasuta, Mundelein, IL (US); Johanna A. Wild, Munich (DE)

Correspondence Address: INGRASSIA FISHER & LORENZ, P.C., 7150 E. CAMELBACK, STE. 325, SCOTTSDALE, AZ, 85251, US

(21) Appl. No.: 11/004,020

(22) Filed: Dec. 2, 2004

(51) Int. Cl. H04M 11/04

(52) U.S. Cl. 379/37; 379/45

(57) ABSTRACT

In one embodiment, a method for executing an emergency plan using a push-to-talk network is disclosed. In a first step, a notification of an emergency is received at an emergency communication platform. Next, a proper response group based on the type of emergency is determined. Then, an emergency message is sent to the response group using the push-to-talk network.

### TECHNICAL FIELD OF THE INVENTION

This invention relates to the field of telecommunications and, more specifically, to a method and apparatus for providing push-to-talk based execution of an emergency plan.

### BACKGROUND OF THE INVENTION

The need to provide prompt, proper response to an emergency situation is of utmost importance. Whether the emergency is a fire, a chemical spill, weather related emergency or any other type of emergency, getting the properly trained emergency responders (such as policemen, firemen, hazardous material personnel and the like) to react quickly can save lives and property. This need is especially acute as states and municipalities formulate emergency response plans as part of an overall homeland security program.

Currently, in the event of an emergency, responders are contacted either by conventional telephonic means or by use of specialized radios. These systems have various drawbacks. First, contacting responders by telephone is a slow process. Even if the calling is automated, making a cellular or landline connection takes a period of time after the number is dialed and the called phone starts to ring. When it is necessary to reach a large group of individuals, this lack of speed can significantly slow down response time.

Radio systems allow for faster contact of responders but have their own set of disadvantages. First, radio systems are not always compatible between types of responders. Therefore, it is difficult to form response teams comprised of responders from different agencies. Also, every person in the response group needs to have their own radios. This can be a costly endeavor.

What is needed is a method and apparatus for providing push-to-talk based execution of an emergency plan.

### SUMMARY OF THE INVENTION

In one embodiment, a method for executing an emergency plan using a push-to-talk network is disclosed. In a first step, a notification of an emergency is received at an emergency communication platform. Next, a proper individual or a response group is selected based on the type and location of emergency. Then, an emergency message is sent to the selected response group using the push-to-talk network.

In another embodiment, a communication platform for enabling push to talk emergency calls is disclosed. The communication platform comprising an emergency PTT server configured to receive a call indicative of an emergency and an emergency database coupled to the emergency PTT server. The emergency database stores a rule set for determining an emergency responder based on the type of emergency.

### BRIEF DESCRIPTION OF THE DRAWINGS

The present invention will hereinafter be described in conjunction with the following drawing figures, wherein like numerals denote like elements, and:

FIG. 1 is a block diagram of a system for providing push-to-talk based emergency response systems in accordance with the teachings of the present invention; and

FIG. 2 is a flowchart illustrating an exemplary method of providing a push-to-talk based emergency plan in accordance with the teachings of the present invention.

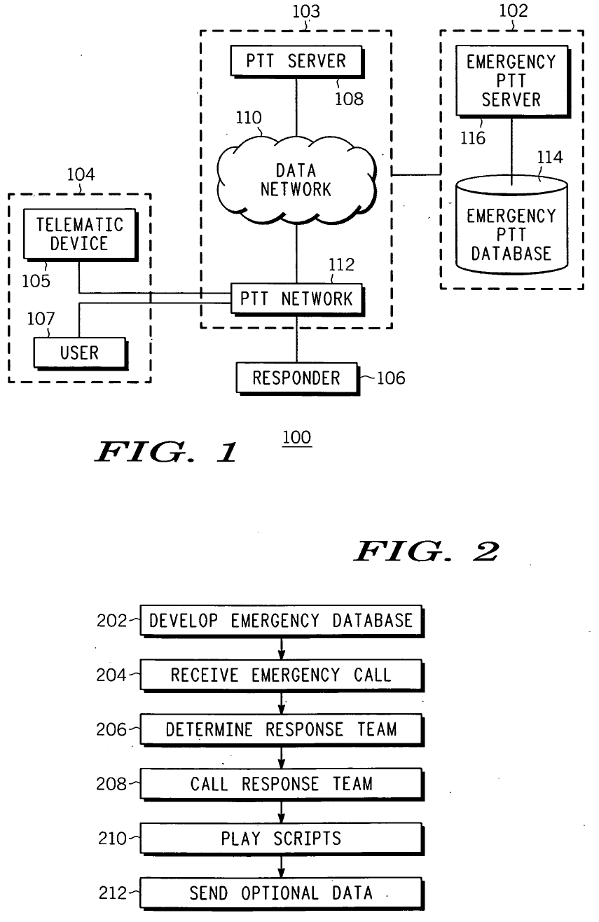

### DETAILED DESCRIPTION OF THE DRAWINGS

The following detailed description is merely exemplary in nature and is not intended to limit the invention or the application and uses of the invention. Furthermore, there is no intention to be bound by any expressed or implied theory presented in the preceding technical, background, brief summary or the following detailed description.

In various embodiments of the present invention, push-to-talk (PTT) systems are utilized to contact individual responders or groups of responders quickly. Currently, PTT services are typically provided over a proprietary network. Since the use of a proprietary network hampers the widespread adoption of PTT services, push-to-talk over cellular (PoC) systems have been developed. PoC utilizes the existing cellular phone system with the addition of a PoC server to provide PTT service. In an exemplary PoC system, the initiator of a PTT call dials an identification number corresponding to the individual or group with whom the call initiator wishes to speak, holds down a push-to-talk button on the cellular phone and speaks. Alternatively, the initiator of the PTT call can select the name of an individual or group of individuals from an address book provided with the phone. The user's speech is digitized and converted into a series of data packets. This process is typically done at the cellular phone, although it could be done at other locations in the PoC system. The dialed identification number or selected address is included in signaling data, which is routed to the PoC server where the identification number can be matched with an identifier of the destination phone or phones. Typically, the identification number is matched with an IP address corresponding to the phone or phones to which the PTT call was sent. The packetized voice data is routed through a network, typically the Internet, to the destination phone or phones. An advantage of a PTT call over a conventional cellular phone call is that a PTT call can be used to quickly reach a group of users and simultaneously deliver a message to all group members.

A push-to-talk based emergency response system and method, according to various aspects of the invention, comprises any system that distributes emergency messages to groups of individuals using a push-to-talk system. The system may include rule sets that can be used to determine which group of responders to call based on the type of emergency. The system may also include the use of prerecorded messages to be played to responders.

For example a push-to-talk emergency response system 100 includes an emergency PTT communication platform 102 coupled to an emergency initiator 104 and an emergency responder 106.

In one embodiment of the present invention, emergency initiator 104 detects an emergency condition and sends notification of the emergency to the emergency PTT communication platform 102. The emergency PTT communication platform 102 receives the notification and based on an emergency identifier such as the type of emergency, the location of the emergency and any other relevant factors or combination of factors, determines the correct group of responders to call for a response. For example, the type of emergency such as fire or flood, can determine the proper responder or group of responders. The location of the emergency can also help determine the proper responder or group of responders in terms of local, regional and/or national responders. The emergency PTT communication platform 102 initiates individual or group PTT calls with the proper responder or group of responders.

The emergency PTT communication platform 102, according to various aspects of the present invention, is any system that can receive a notification of an emergency, determine the correct individual or group to contact and contact the correct individual or group using a PTT system. In one embodiment, emergency PTT communication platform 102 comprises an emergency PTT server 116 and an associated emergency PTT database 114. Emergency PTT communication platform 102 couples to PTT system 103.

Emergency PTT server 116, in one embodiment of the present system handles emergency PTT calls by determining the emergency based on the call, querying the emergency PTT database 114 for proper responders and any necessary pre-generated scripts. Additionally, in one embodiment, emergency PTT server 116 can generate automated responses in real time or near real time to provide information tailored to the particular emergency.

Emergency PTT database 114 can store information necessary for the authorization/authentication of individual users, rule sets for determining the correct individual or group to contact and pre-generated scripted responses to be played to the responders.

The information stored for authentication/authorization can include information defining what members of an emergency response team are authorized to execute an emergency plan. Also, authentication data, such as personal identification numbers associated with authorized users can be stored to provide authentication procedures.

The information to determine the correct response team can include a listing of response teams associated by type of emergency. For example, a fire in a chemical warehouse might be associated with a response team that includes firefighters and specialized hazardous material personnel, as well as specific warehouse personnel. Also, rule sets can be used that associate responders with specific types of emergencies.

Pre-generated scripts can be any combination of voice or data sent to one or more of the response team members containing information concerning the response to the emergency. For example, pre-recorded instructions as to the location of the emergency can be provided. Additionally, if the recipient of the PTT emergency call had a device capable of receiving images, a map of the location of the emergency can be provided. Different scripts can be provided to different individuals or subsections of the response team, the scripts tailored to the task assigned.

Although emergency PTT server 116 is shown as a separate server in one embodiment, emergency PTT database 114 can be deployed as part of PTT server 108. Emergency PTT database 114, while illustrated as a single database, can be deployed as two or more databases.

PTT system 103 can support the reception and delivery of PTT calls. PTT system 103 can act as an interface between PTT systems and non-PTT systems to allow emergency calls to be initiated by non-PTT enabled devices and also allow emergency calls to be received by non-PTT enabled devices. In one embodiment, PTT system 103 comprises a PTT server 108 coupled to a PTT network 112 by a data network 110.

PTT server 108 can provide support for PTT calls including directory services, call control, and data packet routing. Directory services provide a directory of PTT subscribers and can include information regarding how to locate individuals or groups, such as the IP address of the phone for each individual or group member. Call control includes the ability to setup and tear down calls as well as to determine which party is currently the speaking party. Data packet routing includes the ability to route packets of digitized information (e.g. voice, text messages, and multimedia presentations) to the recipients of the PTT call.

Data network 110 receives and transfers data packets, including voice data packets. For PoC embodiments of the present invention, data packets are routed through the network 110 to the PTT server 108 and from the PTT server 108 through the data network 110. Data network 110 can be one of many different types of networks, public or private, including the Internet, local area networks and the like. In one embodiment data network 110 transfers Internet Protocol (IP) data packets between PTT server 108 and PTT network 112.

PTT network 112 can handle emergency PTT calls generated at the PTT server 108 and sent to one or more members of an emergency response group. PTT network 112 also handles PTT calls made to an emergency number to report an emergency and to allow an authenticated user to initiate the execution of an emergency plan. PTT network 112 can be a proprietary network or a cellular telephone network capable of supporting PTT service or a combination of both networks. In one embodiment, PTT network 112 is a GSM cellular network that supports the transfer of data packets via an IP gateway.

In an alternate embodiment, PTT network 112 comprises a PTT interworking interface coupled to a non-PTT enabled network. The PTT interworking interface, by converting between protocols used by a PTT server and those used by non-PTT enabled networks, can allow PTT calls to both reach devices that are not originally designed to handle PTT calls as well as to originate PTT calls from non-PTT enabled devices. A discussion of a PTT interworking interface is provided in U.S. Pat. No. ______, entitled “METHOD AND APPARATUS FOR PROVIDING PUSH-TO-TALK SERVICES TO NON-PUSH-TO-TALK ENABLED NETWORKS” by Armbruster et al. filed on Nov. 15, 2004. This application is herein incorporated by reference.

Emergency initiator 104 sends notification of an emergency to the PTT server 108. In one embodiment, emergency initiator 104 is a telematic device 105 such as a sensor coupled to a telephone dialer. For example, telematic device 105 can be a smoke or heat detection device that can detect the presence of a fire and generate a call to the PTT server 108 to initiate an emergency response. Other sensors such as biological, chemical, radiation, environmental (such as light and luminosity), or weather can be used to initiate an emergency alert. Information regarding the type of emergency can be determined from the type of sensor that initiates the emergency call. For example, if the sensor is a smoke detector in a chemical manufacturing plant, the automated message sent by the phone dialer associated with the sensor includes the information that the fire is in a chemical manufacturing building. Thus, the emergency PTT server 116, using the data stored in emergency PTT database 114, can assemble a response team that can respond to the fire and also a potential hazardous material problem.

In another embodiment, emergency initiator 104 is a user 107 who contacts the PTT server 108, by, in one embodiment, making a PTT call to a predetermined emergency number. In order to safeguard against false reports, only authorized users are able to act as an emergency initiator 104. In one embodiment, authorization can be determine by an identifier associated with the phone of the emergency responder. Then, when a PTT call is made to the PTT server 108, the PTT server 108 checks for the identification of the phone to determine if the phone is associated with an authorized user. As an added measurement of security, authorized users can also be required to authenticate themselves. This can be done, in one embodiment, by requiring all authorized users to enter a personal identification number. In one embodiment, unauthorized emergency callers can be routed to a dispatcher who can assess the situation and initiate an emergency call if needed.

Emergency responder 106 can be any individual or group that can receive a PTT call from PTT server 108 indicating an emergency situation. In a preferred embodiment, emergency responders 106 are identified based on emergency identifiers, such as the type of emergency, by using the emergency PTT database 114. Emergency responders 106 can include specialized responders selected from different organizations, such as fire and police responders. In one embodiment, the makeup of the emergency responders 106 may vary based on which responders can be reached. For example, a predefined list of potential responders can be stored at the emergency PTT database 114. This listing can include a prioritized listing of potential responders 106. If the first responder 106 on the list fails to answer the emergency PTT call, another responder 106 could be called until a responder is reached.

An exemplary method of using a PTT system to execute an emergency plan is illustrated in the flowchart of FIG. 2. In an initial step, step 202, the emergency PTT database 114 is developed. This includes storing listings of emergency responders in groups and associating the groups with the emergency to which the group is suited to respond. The emergency PTT database 114 can also include the identification of authorized individuals for each group and any needed authentication code. Further, the emergency PTT database 114 can include a listing of users authorized to call in and declare an emergency situation. Also, the emergency PTT database 114 can store pre-recorded scripts that can provide the responders with information regarding the emergency.

Once the emergency PTT database 114 is established, the system waits for a call. In step 204, the emergency PTT communication platform 102 receives an emergency call. The call can be initiated by the telematic device 105 such as a sensor coupled to a telephony device. In this embodiment, the sensor, upon detection of an anomaly in the system it is monitoring can initiate an emergency call to the emergency PTT communication platform 102.

Alternatively, authorized individuals can call into the emergency PTT communication platform 102. For example, a fire chief, upon arrival at a hazardous waste fire, can call into the emergency PTT communication platform 102 to activate the response of a hazardous waste management team. In a preferred embodiment, only a preauthorized individual can initiate an emergency response. In one embodiment, authorized user can be required to authenticate themselves using a personal identification number, voice recognition, answering of personal question, and the like. A unique group can be created to assign for this emergency situation. This unique group can then be used to respond to similar emergencies and for all emergency call information exchanges between emergency responders.

In one embodiment, emergency PTT calls can be given priority in a PoC system over other PTT calls. This can help to ensure that emergency PTT calls can be received even if the PTT system is experiencing high call volume.

In step 206, the proper response team is determined. The composition of the emergency response team is based on the type of emergency, but other factors, such as location, available specialized equipment and the like also help determine the proper response team. Once the type of emergency is determined, the emergency PTT database 114 can be used to develop the proper response team.

Then, in step 208, a PTT call is made to the response group or to a subset of the response group. Indeed, different groups may be called at different times. Because the present invention utilizes PTT calls, when a response group is called all group members simultaneously hear the emergency message.

In step 210, stored scripts are played to the recipients of the emergency PTT call. In one embodiment, different scripts may be played to different individuals or different groups or subgroups. For example, in response to a fire at a hazardous waste plant, the members of the fire department may receive a different message from the members of the hazardous waste team. Pre-recorded scripts can be elaborate instructions or just a simple statement of an emergency condition.

Optionally, data such as pictures, maps and the like can be sent to the recipients of the PTT call in step 212.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed:

1. A method for executing an emergency plan using a push-to-talk network comprising:
receiving a notification of an emergency at an emergency communication platform, the notification including an emergency identifier;
determining a proper response group based on the emergency identifier; and
sending an emergency message to the proper response group using the push-to-talk network.

2. The method of claim 1 further comprising the step of playing an automated message as the emergency message.

3. The method of claim 1 wherein the step of playing an automated message further comprises playing a pre-recorded message.

4. The method of claim 1 wherein the step of playing an automated message further comprises playing a message generated by the emergency platform.

5. The method of claim 1 wherein the step of receiving notification further comprises receiving notification of an emergency at an emergency communication platform from a remote sensor.

6. The method of claim 5 wherein the step of receiving notification further comprises receiving notification of an emergency condition from a fire sensor.

7. The method of claim 1 wherein the step of receiving notification further comprises receiving notification of an emergency at an emergency communication platform from an authorized individual.

8. The method of claim 7 further comprising receiving an authenticated personal identification number from the authorized individual.

9. The method of claim 1 further comprising the step of playing a first emergency response message to a first subset of the proper response group and playing a second emergency response message to a second subset of the proper response group.

10. The method of claim 1 wherein the step of determining a proper response group further comprises determining a proper response group based on a type of emergency.

11. The method of claim 1 wherein the step of determining a proper response group further comprises determining a proper response group based on a location of the emergency.

12. The method of claim 1 further comprising sending data to at least one of the members of the response group.

13. The method of claim 12 wherein the step of sending data further comprises sending a map of the location of the emergency.

14. The method of claim 9 wherein the step of playing a first emergency response message playing a first emergency response message to a first subset of the response group and playing a second emergency response message to a second subset of the response group.

15. A communication platform for enabling push to talk emergency calls comprising:
an emergency PTT server configured to receive a call indicative of an emergency, the call including an emergency identifier; and
an emergency database coupled to the emergency PTT server, the emergency database storing information for determining an emergency responder based on the emergency identifier.

16. The communication platform of claim 15 wherein the emergency responder comprises two or more groups of responders from different organizations.

17. The communication platform of claim 15 wherein the emergency database stores pre-recorded scripts that can be played to the emergency responders.

18. The communication platform of claim 15 wherein the call is received from a telematic device.

19. The communication platform of claim 15 wherein the call is received from an authorized user.

20. The communication platform of claim 15 further comprising a PTT system coupled to the emergency PTT server.

21. The communication platform of claim 20 wherein the PTT system is configured to convert a non-PTT call to a PTT call.

22. The communication platform of claim 20 wherein the PTT system is configured to convert a PTT call to a non-PTT call.

23. The communication platform of claim 15 wherein the emergency PTT server is configured to generate a PTT call to the correct emergency responder.

24. The communication platform of claim 15 wherein the emergency PTT server is configured to generate an emergency message.

25. An emergency response system comprising:
an emergency server configured to receive an emergency call, the emergency call including an emergency identifier;
an emergency database coupled to the emergency server, the emergency database storing information for determining an emergency responder based on the emergency identifier received with the emergency call; and
a PTT server coupled to the emergency server, the PTT server configured to send a PTT emergency call to the emergency responders.

26. The apparatus of claim 25 wherein the proper responder comprises two or more groups of responders from different organizations.

27. The apparatus of claim 25 wherein the emergency database stores pre-recorded scripts that can be played to the proper responders.

28. The apparatus of claim 25 wherein the emergency call is received from a telematic device.

29. The apparatus of claim 25 wherein the call is received from an authorized user.

30. The apparatus of claim 25 wherein the PTT system is configured to convert a non-PTT call to a PTT call.

31. The apparatus of claim 25 wherein the PTT system is configured to convert a PTT call to a non-PTT call.

32. The apparatus of claim 25 wherein the emergency server is configured to generate an emergency message.
